(19) United States
(12) Patent Application Publication
(10) Pub. No.: US 2010/0036082 A1
(43) Pub. Date: Feb. 11, 2010

(54) POLYMER POLYOL, METHOD FOR PRODUCING THE SAME, AND METHOD FOR PRODUCING POLYURETHANE

(75) Inventors: Shigekuni Nakada, Kyoto (JP); Tomohisa Hirano, Kyoto (JP); Takayuki Tsuji, Kyoto (JP)

Correspondence Address: HAMRE, SCHUMANN, MUELLER & LARSON, P.C., P.O. BOX 2902, MINNEAPOLIS, MN, 55402-0902, US

(73) Assignee: SANYO CHEMICAL INDUSTRIES, LTD., Kyoto-shi, Kyoto (JP)

(21) Appl. No.: 12/522,655

(22) PCT Filed: Dec. 13, 2007
(86) PCT No.: PCT/JP2007/074054

§ 371 Date: Jul. 9, 2009

(30) Foreign Application Priority Data
Jan. 10, 2007 (JP) 2007-002880

(51) Int. Cl. C08G 18/32; B32B 5/16; C08G 67/00

(52) U.S. Cl. 528/85; 528/392; 428/402

(57) ABSTRACT

A polymer polyol (A) that comprises a polyol (PL) and polymer particles (JR) having an ethylenically unsaturated compound (E) as a constituent unit and contained in a polyol (PL) is provided, in which a ratio of acrylonitrile in (E) is 0 mol % to 67 mol %, and relationship between a viscosity of the polymer polyol and a content (PC) of the polymer particles satisfies a formula (1) below, and/or satisfies formulae (2) and (3) below:

(N1)<0.9×(PC)−35 (1)

(N2)<1.17×(PC)−46 (2)

(N3)<1.37×(PC)−55 (3)

where N1, N2, and N3 represent viscosities (Pa·s) of the polymer polyol at 25° C. at a shearing speeds of 1.0 (l/s), 0.1 (l/s), and 10.0 (l/s), respectively, measured by a rheometer; and PC represents a content (wt %) of (JR) in the polymer polyol. This polymer polyol is useful as a polyol component of a raw material for polyurethane, significantly improves mechanical properties of a polyurethane to be obtained, and further, facilitates the maintenance of a polyurethane producing device since causing less clogging in a discharge head of a polyurethane foaming device, thereby enhancing the productivity.

### TECHNICAL FIELD

The present invention relates to a polymer polyol, a method for producing the same, and a method for producing polyurethane in which the foregoing polymer polyol is used. More specifically, the present invention relates to a polymer polyol that is suitable as a raw material for a polyurethane (polyurethane foam, polyurethane elastomer, etc.), has an excellent filtration property, and imparts excellent mechanical properties to the polyurethane; to a method for producing the polymer polyol; and to a method for producing a polyurethane in which the foregoing polymer polyol is used.

### BACKGROUND ART

Conventionally, as to a polymer polyol obtained by polymerizing an ethylenically unsaturated compound containing acrylonitrile in a polyol, it has been requested that a ratio of acrylonitrile in an ethylenically unsaturated compound be reduced (to 67 mol % or less) to improve the resistance to scorching of a polyurethane foam in which the foregoing polymer polyol is used as a raw material. As the polymer polyol in which a ratio of acrylonitrile in a polymer is decreased so that a ratio of styrene is increased, the following are known: a polymer polyol whose particle size distribution is specified [a ratio of a mode value (% by volume) and {a difference (μm) between a maximum particle diameter and a minimum particle diameter} is not more than 2 in a volume-based particle size distribution] (see Patent Document 1, for example); and a polymer polyol in which a concentration of coarse particles having a diameter of 100 μm or more is 5 to 120 ppm, the polymer polyol being obtained by a continuous polymerization production method in which a dissolved oxygen concentration is controlled to 5 to 120 ppm (see Patent Document 2, for example).

Patent Document 1: JP 11 (1999)-236499 A

Patent Document 2: JP 2005-162791 A

### DISCLOSURE OF INVENTION

### Problem to be Solved by the Invention

The foregoing conventional polymer polyols, however, have problems such as the following, since coarse particles exist in the case of the former, or since the particle size distribution is broad in the case of the latter: when a polyurethane foam is produced by mechanical foaming with use of the foregoing polymer polyol as a raw material, the inside of a discharge head of a foaming machine is dogged, and the operation of the foaming machine stops frequently. Besides, a polyurethane foam made of the foregoing polymer polyol as a raw material has problems such as decreases in its tensile strength and elongation at break.

It is an object of the present invention to provide a polymer polyol that solves the foregoing problems, that provides an excellent filtration property when a polyurethane foam is produced by mechanical foaming with use of the polymer polyol as a raw material, that does not cause clogging in the inside of the discharge head for a polyurethane foam, thereby providing excellent productivity, and with which a polyurethane foam having excellent tensile strength and excellent elongation at break can be obtained; to provide a method for producing the same; and to produce a method for producing a polyurethane in which the foregoing polymer polyol is used as a part of raw materials.

### Means to Solve the Problem

To achieve the above-described object, a polymer polyol of the present invention is a polymer polyol (A) comprising a polyol (PL) and polymer particles (JR), the polymer particles (JR) having an ethylenically unsaturated compound (E) as a constituent unit and being contained in the polyol (PL), wherein

a ratio of acrylonitrile in the ethylenically unsaturated compound (E) is 0 mol % to 67 mol %, and

relationship between a viscosity of the polymer polyol and a content (PC) of the polymer particles satisfies a formula (1) below, and/or satisfies formulae (2) and (3) below:

(N1)<0.9×(PC)−35 (1)

(N2)<1.17×(PC)−46 (2)

(N3)<1.37×(PC)−55 (3)

where

N1 represents a viscosity (Pa·s) of the polymer polyol at 25° C. at a shearing speed of 1.0 (l/s) measured by a rheometer,

N2 represents a viscosity (Pa·s) of the polymer polyol at 25° C. at a shearing speed of 0.1 (l/s) measured by a rheometer,

N3 represents a viscosity (Pa·s) of the polymer polyol at 25° C. at a shearing speed of 10.0 (l/s) measured by a rheometer, and

PC represents a content (wt %) of the polymer particles (JR) in the polymer polyol.

Further, a method for producing a polymer polyol according to the present invention is a method for producing the above-described polymer polyol, and the method includes the step of polymerizing an ethylenically unsaturated compound (E) in a polyol (PL), in the presence or absence of a dispersant (B), wherein 0.1 wt % to 10 wt % of the ethylenically unsaturated compound (E) is (poly)oxyalkylene (with an alkylene group having 2 to 8 carbon atoms) ether of unsaturated alcohol (having 3 to 24 carbon atoms).

Still further, a method for producing a polyurethane according to the present invention is a method for producing a polyurethane by causing a polyol component and an isocyanate component to react with each other, wherein as the polyol component, a polyol component containing the polymer polyol (A) according to claim 1 is used, the polymer polyol (A) being 10 wt % to 100 wt % based on a weight of the polyol component.

### EFFECT OF THE INVENTION

The polymer polyol (A) of the present invention, and the polyurethane in which the polymer polyol (A) is used, achieve the following effects:

(1) the polymer polyol (A) facilitates the maintenance of a polyurethane producing device, and improves the productivity; and

(2) the polyurethane produced with use of the polymer polyol (A) has excellent mechanical properties.

### DETAILED DESCRIPTION OF THE INVENTION

A polymer polyol in the present invention comprises a polyol (PL) and polymer particles (JR) obtained by polymerizing an ethylenically unsaturated compound (E), the particle (JR) being contained in the polyol (PL). Examples of the ethylenically unsaturated compound (E) that can be used herein include styrene (hereinafter abbreviated as “St”), acrylonitrile (hereinafter abbreviated as “ACN”), and other ethylenically unsaturated monomers (e). It is preferable that, as the ethylenically unsaturated compound (E), St and/or ACN is contained as an essential component.

The percentage (mol %) of St based on the total number of moles of the ethylenically unsaturated compound (E) composing the polymer particles (JR) is preferably 33 to 83 mol %, more preferably 35 to 70 mol %, further more preferably 40 to 65 mol %, and most preferably 50 to 60 mol % from the viewpoint of the discoloration of polyurethane and the content of coarse particles.

The percentage (mol %) of ACN based on the total number of moles of the ethylenically unsaturated compound (E) composing the polymer particles (JR) is 0 to 67 mol %, preferably 30 to 65 mol %, more preferably 35 to 60 mol %, and most preferably 40 to 50 mol % from the viewpoint of the content of coarse particles and the discoloration of polyurethane.

The molar ratio between St and ACN (St:ACN) is preferably 83:17 to 33:67, more preferably 70:30 to 35:65, and most preferably 60:40 to 50:50, for the same reasons as those described above for the percentages of St and ACN in the ethylenically unsaturated compound.

The above-mentioned other ethylenically unsaturated monomers (e) are not limited particularly as long as the monomer has two or more carbon atoms, has a number-average molecular weight hereinafter abbreviated as “Mn”) [measured by gel permeation chromatography (GPC)] of less than 1,000, and is copolymerizable with St and/or ACN. Examples of the other ethylenically unsaturated monomers (e) that can be used herein include those that are monofunctional [unsaturated nitrile (e1), aromatic-ring-containing monomers (e2), (meth)acrylic acid esters (e3), polyoxyalkylene ethers of α-alkenyl group containing compounds (e4), and other ethylenically unsaturated monomers (e5)], and multifunctional monomers (e6) (having two or more functional groups). These may be used alone or in combinations of two or more.

Examples of (e1) include methacrylonitrile.

Examples of (e2) include α-methylstyrene, hydroxystyrene, and chlorostyrene.

Examples of (e3) include (meth)acrylic acid alkyl esters (with an alkyl group having 1 to 24 carbon atoms) such as methyl (meth)acrylate, butyl (meth)acrylate, nonyl (meth)acrylate, decyl (meth)acrylate, undecyl (meth)acrylate, dodecyl (meth)acrylate, tridecyl (meth)acrylate, tetradecyl (meth)acrylate, pentadecyl (meth)acrylate, hexadecyl (meth)acrylate, octadecyl (meth)acrylate, eicosyl (meth)acrylate, docosyl (meth)acrylate; and hydroxypolyoxyalkylene (with an alkylene group having 2 to 8 carbon atoms) mono(meth)acrylates.

It should be noted that “(meth)acrylic acid ester” means acrylic acid ester and/or methacrylic acid ester. This applies to (meth)acrylic acid, (meth)allyl, and the like described below. This notation is used hereinafter.

Examples of (e4) include alkylene oxide (hereinafter abbreviated as “AO”) adducts of unsaturated alcohol having 3 to 24 carbon atoms. As the unsaturated alcohol, terminal-unsaturated alcohol is used preferably. Examples of the terminal-unsaturated alcohol include allyl alcohol, 2-butene-1-ol, 3-butene-2-ol, 3-butene-1-ol, and 1-hexene-3-ol. Preferred among these is an AO adduct of allyl alcohol. The number of added moles of OA is preferably 1 to 9, more preferably 1 to 6, and particularly preferably 1 to 3.

Examples of the aforementioned AO include those having 2 to 12 or more carbon atoms such as ethylene oxide, 1,2-propylene oxide, 1,2-, 2,3-, or 1,3-butylene oxide, tetrahydrofuran, and 3-methyl-tetrahydrofuran (hereinafter abbreviated as “EO”, “PO”, “BO”, “THF”, and “MTHF”, respectively); 1,3-propylene oxide; isoBO; α-olefin oxide having 5 to 12 carbon atoms; substituted AO (such as styrene oxide and epihalohydrin); and combinations of two or more of these (random addition and/or block addition).

Among these 1,2-PO and/or EO is preferred.

(e4) has a Mn of 110 to 490 preferably, and the lower limit of the same is preferably 112, more preferably 116, particularly preferably 170, and most preferably 180. The upper limit thereof is preferably 480, more preferably 450, particularly preferably 420, and most preferably 300. When Mn is 110 or more, the polymer polyol has a low viscosity, which is preferred from the viewpoint of handleability, and a polyurethane obtained from the polymer polyol has an excellent hardness. When Mn is 490 or less, a polyurethane obtained with use of the polymer polyol has an excellent hardness.

The number of α-alkenyl groups of (e4) is not less than 1 in average, and from the viewpoint of the viscosity of the polymer polyol and the physical properties of the polyurethane to be described later, the foregoing number is preferably 1 to 10, more preferably 1 to 2, and particularly preferably 1.

From the viewpoint of the viscosity of the polymer polyol and the compression hardness of the polyurethane to be described later, a solubility parameter (hereinafter referred to as “SP value”) of (e4) is preferably 9.5 to 13, more preferably 9.8 to 12.5, and particularly preferably 10 to 12.2.

It should be noted that the SP value is expressed as a square root of a ratio of a cohesive energy density and a molecular volume as shown below:

SP value=(ΔE/V)^{1/2}

where ΔE represents a cohesive energy density, and V represents a molecular volume. The SP value is determined by the calculation of Robert F Fedors et al., which is described, for example, in Polymer Engineering and Science, Volume 14, pages 147 to 154.

As the other ethylenically unsaturated monomers (e5), an ethylenically unsaturated monomer having 2 to 24 carbon atoms is preferable. Examples of the same include vinyl-group-containing carboxylic acids such as (meth)acrylic acids; aliphatic hydrocarbon monomers such as ethylene and propylene; fluorine-containing vinyl monomers, such as perfluorooctylethyl methacrylate and perfluorooctylethyl acrylate; nitrogen-containing vinyl monomers other than unsaturated nitrile, such as diaminoethyl methacrylate and morpholinoethyl methacrylate; vinyl-modified silicone; and cyclic olefin or diene compounds, such as norbornene, cyclopentadiene, and norbornadiene.

As the multifunctional monomer (e6), a multifunctional monomer having 8 to 40 carbon atoms is preferable. Examples of the same include divinyl benzene, ethylene di(meth)acrylate, polyalkylene oxide glycol di(meth)acrylate, pentaerythritol triallyl ether, and trimethylolpropane tri(meth)acrylate.

Among (e1) to (e6), from the viewpoint of the viscosity of the polymer polyol and the physical properties of the polyurethane, (e3), (e4), and (e6) are preferable; among these, (e4) and (e6) are more preferable; among these, PO and/or EO adducts of terminal-unsaturated alcohols, and difunctional monomers are particularly preferable; and among these, PO adducts of allyl alcohol and divinyl benzene are most preferable.

The ratio (mol %) of the above-described other ethylenically unsaturated monomer (e) in the ethylenically unsaturated compound (E) composing the polymer particles (JR) is preferably not more than 40 mol %. From the viewpoint of the viscosity and the dispersion stability of the polymer polyol, and the physical properties of polyurethane, the ratio is more preferably 0.01 to 30 mol %, further preferably 0.05 to 20 mol %, particularly preferably 0.1 to 15 mol %, and most preferably 0.2 to 10 mol %.

Particularly, the amount used (wt %) of (e4) based on the weight of (E) is preferably 0.1 to 10 wt %, more preferably 1 to 8 wt %, and further preferably 1 to 6 wt %. When the foregoing amount is in this range, a polymer polyol obtained has a low viscosity, and hence, it is easy to obtain the polymer polyol of the present invention.

As the polyol (PL), a known polyol used for producing a polymer polyol can be used (e.g. those described in JP 2005-162791 A, JP 2004-018543 A, JP 2004-002800 A (corresponding to US Patent Application Pub. No. 2005/245724 A1).

Specific examples of the polyol (PL) include, for example, compounds having a structure such that AO is added to a compound containing at least 2 (preferably 2 to 8) active hydrogen atoms (polyhydric alcohol, polyhydric phenol, amine, polycarboxylic acid, phosphoric acid, etc.), and mixtures of these. Among these, AO adducts of polyhydric alcohols are preferable from the viewpoint of the mechanical properties of the polyurethane.

Examples of the AO include those described above. From the viewpoint of the mechanical properties of the polyurethane obtained, AO having 2 to 8 carbon atoms are preferable among the foregoing AOs; among these, more preferable are EO, PO, 1,2-, 2,3-, and 1,3-butylene oxide, tetrahydrofuran, styrene oxide, and a combination of two or more (block addition and/or random addition); and among these, particularly preferable are PO, or combination of PO and EO [the content of EO is not more than 25% based on the weight of (PL), and preferably 1 to 20%].

Examples of the above-described AO adduct include PO adducts of known active-hydrogen-containing compounds {JP 2005-162791 A, JP 2004-002800 A (corresponding US Patent Application Pub. No. 2005/245724A1), etc.}, adducts obtained by adding PO and another AO (preferably EO) in the following manner, and esterification products of such adducts with polycarboxylic acid or phosphoric acid:

(1) block addition of (PO block)-(another AO block) in this order;

(2) block addition of [(PO block)-(another AO block)]₂ in this order;

(3) block addition of (another AO block)-(PO block)-(another AO block) in this order;

(4) block addition of (PO block)-(another AO block)-(PO block) in this order;

(5) random addition of PO and another AO; and

(6) random and block addition in the order described in U.S. Pat. No. 4,226,756.

The polyol (PL) is preferably an adduct of an active-hydrogen-containing compound, or a polyol containing the foregoing. In the case where the adduct is contained, the content of the same is preferably 80 to 100 wt %, more preferably 85 to 100 wt %, and particularly preferably 90 to 100 wt % based on the weight of (PL) from the viewpoint of the mechanical properties of the polyurethane to be obtained.

The polyol (PL) has a hydroxyl equivalent (the measurement of the same is according to JIS K-1557-1970 (ISO-14900-2001)) of preferably 200 to 4,000, and more preferably 400 to 3,000 from the viewpoint of the viscosity of the polymer polyol and the mechanical properties of the polyurethane.

The polyol (PL) has a Mn of preferably 500 to 20,000, more preferably 1,200 to 15,000, and particularly preferably 2,000 to 9,000. When Mn is 500 or more, such a polyol (PL) is preferable from the viewpoint of the mechanical properties of the polyurethane to be described later. When Mn is 20,000 or less, such a polyol (PL) makes the polymer polyol have a lower viscosity, and therefore is preferable from the viewpoint of the handling properties of the polymer polyol.

The polymer polyol (A) of the present invention is configured so that the relationship between a content (PC) of the polymer particles in (A) and a viscosity (N1) of (A) at 25° C. at a shearing speed of 1.0 (l/s) measured by a rheometer satisfies a formula (1) shown below, and preferably satisfies a formula (1-1) shown below. It should be noted that the viscosity is measured by a method described later.

(N1)<0.9×(PC)−35 (1)

(N1)<0.9×(PC)−35.5 (1-1)

Alternatively, the polymer polyol (A) of the present invention is configured so that the relationship between the content (PC) of the polymer particles in (A) and a viscosity (N2) of (A) at 25° C. at a shearing speed of 0.1 (l/s) measured by a rheometer, and the relationship between the foregoing content (PC) and a viscosity (N3) of (A) at 25° C. at a shearing speed of 10.0 (l/s) measured by a rheometer satisfy the formulae (2) and (3) shown below, and preferably satisfy the formulae (2-1) and (3-1) shown below. It should be noted that the viscosities are measured by a method described later.

(N2)<1.17×(PC)−46 (2)

(N2)<1.17×(PC)−47 (2-1)

(N3)<1.37×(PC)−55 (3)

(N3)<1.37×(PC)−56 (3-1)

The polymer polyol (A) of the present invention may satisfy all of the foregoing relationships expressed by the formulae (1), (2), and (3), may satisfy only the relationship expressed by the formula (1), or may satisfy only the relationships expressed by the formulae (2) and (3). Among these cases, the case where all of the relationships expressed by the formulae (1), (2), and (3) are satisfied are preferred.

In any of the cases where the formula (1) is not satisfied, the case where the formula (2) is not satisfied, and the case where the formula (3) is not satisfied, the filtration property of the polymer polyol deteriorates.

The content (PC) of the polymer particles in the polymer polyol (A) is preferably 30 to 65 wt %, more preferably 35 to 60 wt %, particularly preferably 38 to 57 wt %, and most preferably 40 to 55 wt %, from the viewpoint of the mechanical properties of the polyurethane and the prevention of aggregation of the polymer particles (JR) in the polymer polyol to be described later. The (PC) is measured by a method described later.

The content (wt %) of the polyol (PL) in the polymer polyol (A) is preferably 35 to 70 wt %, more preferably 40 to 65 wt %, particularly preferably 43 to 62 wt %, and most preferably 45 to 60 wt %, from the viewpoint of the prevention of aggregation of the polymer particles (JR) and the mechanical properties of the polyurethane to be obtained.

The shape of the polymer particle (JR) is not limited particularly, and the polymer particle (JR) may have any shape such as a spherical shape, a spheroidal shape, or a flat shape. The shape however is preferably a spherical shape, form the viewpoint of the mechanical properties of the polyurethane.

The polymer particles (JR) have a volume-average particle diameter (μm) of preferably 0.2 to 0.9 μm, more preferably 0.25 to 0.8 μm, and particularly preferably 0.3 to 0.7 μm, from the viewpoint of the viscosity of the polymer polyol and the polyurethane properties. It should be noted that the volume-average particle diameter is measured by a method described later.

Examples of the method for producing the polymer polyol (A) of the present invention include the following producing methods (1) and (2):

(1) a producing method in which the ethylenically unsaturated compound (1) is polymerized in the polyol (PL); and

(2) a producing method in which the ethylenically unsaturated compound (E) is polymerized to form the polymer particles (JR), and thereafter the polymer particles (JR) are dispersed in the polyol (PL).

The producing method (1) described above is a method in which the ethylenically unsaturated compound (E) is polymerized in a dispersion medium made of the polyol (PL).

Examples of the polymerization method include radical polymerization, coordinated anionic polymerization, metathesis polymerization, and Diels-Alder polymerization. Among these, radical polymerization is preferred from the industrial viewpoint.

As the radical polymerization, various methods are usable, for example, a method in which the ethylenically unsaturated compound (E) is polymerized in the polyol (PL) containing a dispersant (B) in the presence of a radical polymerization initiator (K) (the method described in U.S. Pat. No. 3,383,351, etc.).

As the radical polymerization initiator (K), a compound that forms a free radical to initiate polymerization may be used. Examples of the same include azo compounds and peroxides (those described in JP 2005-162791 A, JP 2004-002800 A (corresponding to US 2005/245724A1), etc.). Besides, (K) has a 10-hour half-life temperature of preferably 30 to 150° C., more preferably 40 to 140° C., and particularly preferably 50 to 130° C., from the viewpoint of the polymerization ratio and polymerization time of (E) and the productivity of the polymer polyol.

The amount of (K) (wt %) used is preferably 0.05 to 20 wt %, more preferably 0.1 to 5 wt %, and particularly preferably 0.2 to 2 wt % based on the total weight of (E) from the viewpoint of the polymerization degree of (E) and the mechanical properties of the polyurethane to be obtained.

As the dispersant (B), various dispersants having a Mn of not less than 1,000 (preferably 1,000 to 10,000) may be used, for example, a known dispersant used in the polymer polyol production {those described in JP 2005-162791 A, JP 2004-002800 (corresponding to US Patent Application Pub. No. 2005/245724 A1) and the like} and the like can be used. Examples of this dispersant (B) include a reactive dispersant having an ethylenically unsaturated group copolymerizable with St or ACN, and a non-reactive dispersant that is not copolymerizable with St or ACN.

It should be noted that the reactive dispersant having an ethylenically unsaturated group has a Mn of not less than 1,000, and is distinguished from an ethylenically unsaturated monomer (e) having a Mn of less than 1,000.

Specific examples of the dispersant (B) include the following:

[1] macromer-type dispersants, such as an ethylenically unsaturated group-containing modified polyether polyol {described in JP 08 (1996)-333508 A, JP 2004-002800 A (corresponding to US Patent Application Pub. No. 2005/245724 A1), etc.} obtained by causing at least a part of hydroxyl groups of a polyol (PL) to react with methylene dihalide and/or ethylene dihalide to increase the molecular weight thereof, and causing the reaction product further to react with an ethylenically unsaturated compound;

[2] graft-type dispersants obtained by combining a polyol with an oligomer, such as a graft polymer having, as side chains, two or more segments with an affinity for polyols (PL), in which the difference between the solubility parameter of the side chains and the solubility parameter of a polyol (PL) is not more than 1.0, and having, as a main chain, a segment with an affinity for the polymer particles (JR), in which the difference between the solubility parameter of the main chain and the solubility parameter of the polymer formed from an ethylenically unsaturated compound is not more than 2.0 (described in JP 05 (1993)-059134A, etc.);

[3] high-molecular-weight polyol type dispersants, e.g. a modified polyol obtained by causing at least a portion of the hydroxyl groups in a polyol (PL) to react with a methylene dihalide and/or an ethylene dihalide to increase its molecular weight (described in JP 07 (1995)-196749 A, etc.);

[4] oligomer type dispersants, such as a dispersant comprising the following two in combination: a vinyl oligomer with a weight-average molecular weight (hereinafter abbreviated as Mw) of 1,000 to 30,000 [measured by gel permeation chromatography (GPC)], at least a portion of which is soluble in polyols (PL); and an ethylenically unsaturated group-containing modified polyol obtained by causing the foregoing oligomer to react with the high-molecular-weight modified polyol described in [3] above (described in JP 09 (1997)-77968 A, etc.); and

[5] reactive dispersants, such as a dispersant comprising a nitrogen-bond-containing unsaturated polyol obtained by combining a polyol (PL) and a monofunctional active hydrogen compound via polyisocyanate, the monofunctional active hydrogen compound having at least one ethylenically unsaturated group (described in JP 2002-308920 A (corresponding to U.S. Pat. No. 6,756,414), etc.).

Among these, from the viewpoint of the particle diameter of the polymer particles (JR), [1], [4], and [5] are preferable. Particularly preferable is [5].

The amount (wt %) of the dispersant (B) used is preferably 2 to 20 wt % based on the weight of the polyol (PL), and more preferably 5 to 15 wt %, from the viewpoint of the particle diameter of the polymer particles (JR) and the viscosity of the polymer polyol. When the amount is in this range, the production of the polymer polyol of the present invention is facilitated.

In the radical polymerization, a diluent (c) may be used as required. Examples of the diluent (c) include aromatic hydrocarbons (having 6 to 10 carbon atoms) (e.g. toluene and xylene); saturated aliphatic hydrocarbons (having 5 to 15 carbon atoms) (e.g. hexane, heptane, and normal decane); unsaturated aliphatic hydrocarbons (having 5 to 30 carbon atoms) (e.g. octene, nonene, and decene); and other known solvents (described in JP 2005-162791 A, etc.). Among these, aromatic hydrocarbon solvents are preferable from the viewpoint of the viscosity of the polymer polyol.

The amount (wt %) of the diluent (c) used is preferably 0.1 to 50 wt %, and more preferably 1 to 40 wt %, based on the total weight of the ethylenically unsaturated compound (E), from the viewpoint of the viscosity of the polymer polyol and the mechanical properties of the polyurethane. The diluent (c) may remain in the polymer polyol after the polymerization reaction ends, but desirably is removed by vacuum stripping or the like after the polymerization reaction from the viewpoint of the mechanical properties of the polyurethane.

Further, a chain transfer agent (g) may be used as required in the radical polymerization. As the chain transfer agent (g), various chain transfer agents can be used, such as aliphatic thiols (having 1 to 20 carbon atoms) (e.g. n-dodecane thiol, mercaptoethanol) (described in JP 2005-162791 A, JP 2004-002800 A (corresponding to US Patent Application Pub. No. 2005/245724 A1), etc.).

The amount (wt %) of the chain transfer agent (g) used is preferably 0.01 to 2 wt %, and more preferably 0.1 to 1 wt %, based on the total weight of the ethylenically unsaturated compound (E), from the viewpoint of the viscosity of the polymer polyol and the mechanical properties of the polyurethane to be obtained.

Focusing on the polymerization step, the polymer polyol can be produced by a producing method comprising a known step for producing a polymer polyol, such as a batch method and a continuous method {described in JP 2005-162791 A, JP 8 (1996)-333508 A, JP 2004-002800 A (corresponding to US Patent Application Pub. No. 2005/245724 A1), etc.}. As the step for obtaining the polymer polyol of the present invention, the batch polymerization method or the continuous polymerization method is preferable, and the multi-stage one-step polymerization method or the multi-stage continuous polymerization method is more preferable.

The multi-stage one-step polymerization method is a polymerization method including n polymerization steps (n is an integer of not less than 2), and includes the following steps (I) to (III). This producing method may be configured in any way as long as the steps (I) to (III) are carried out in this order, and these steps may be carried out in one reaction container, or different reaction containers, respectively:

(I) charging the ethylenically unsaturated compound (E), and the polyol (PL), as well as the dispersant (B) and the diluent (c) as required, and thereafter adding the radical polymerization initiator (K) so as to cause polymerization, whereby a base polymer polyol (BA1) is obtained;

(II) adding (E), as well as (PL), (B), and (c) as required, to the obtained polymer polyol (BAi-1), and thereafter adding (K) so as to cause polymerization, whereby a base polymer polyol (BAi) is obtained [i is an integer of 2 to (n−1)]. It should be noted that this step (II) is not carried out when n is 2, but is carried out (n−2) times when n is not less than 3, whereby at the end of the step (II), a base polymer polyol (BAn−1) is obtained; and

(III) adding (E), as well as (PL), (B), and (c) as required, to the obtained (BAn−1), and thereafter adding (K) so as to cause polymerization, whereby the polymer polyol (A) is obtained.

The number n of the polymerization stages is the number of steps in which polymerization is performed, and is the total number of polymerization stages of the foregoing (I), (II), and (III).

The number n is preferably 2 to 7, more preferably 2 to 5, and particularly preferably 3 to 4, from the viewpoint of the content of coarse particles.

The radical polymerization initiator (K) may be used as it is, or alternatively, the radical polymerization initiator (K) dissolved (or dispersed) in the diluent (c), the dispersant (B), and/or the polyol (PL) may be used.

The aforementioned producing method (2) is a method in which the polymer particles (JR) are produced and thereafter are dispersed in the polyol (PL), whereby a polymer polyol is obtained. Examples of the producing method (2) include the following methods:

First, the polymer particles (JR) are produced by emulsion polymerization or suspension polymerization of the ethylenically unsaturated compound (E) by any of various methods (methods described in JP 5 (1993)-148328 A, JP 8 (1996)-100006 A, etc.). The (JR) obtained are classified with a wet classifier (of a settling tank type, a mechanical classifier type, a centrifugal classifier type, etc.), whereby the polymer particles (JR) satisfying an arithmetic standard deviation and a coarse particle content specified in the present invention are obtained. If (JR) obtained by polymerization satisfy the arithmetic standard deviation and the coarse particle content specified in the present invention, the classification process does not need to be performed. The polymer polyol (A) can be obtained by dispersing the polymer particles (JR) obtained herein in the polyol (PL). For dispersion, a dispersion liquid in which (JR) is dispersed (hereinafter referred to as “(JR) dispersion liquid”), which is obtained by polymerization or wet classification, may be used as it is, or the (JR) dispersion liquid from which the solvent already has been removed by distillation may be used. In the case where the polymer particle (JR) dispersion liquid is used as it is, the polymer polyol of the present invention can be obtained by adding the polyol (PL) to the (JR) dispersion liquid and thereafter removing the solvent by distillation. In the case where the polymer particle (JR) dispersion liquid from which the diluent has been removed already by distillation is used, when the polymer particles (JR) are dispersed in the polyol (PL), a high shearing power should be applied; by doing so, the (JR) can be prevented from aggregating, and this facilitates the obtainment of the polymer polyol of the present invention. As a preferable device used for dispersion is a device performing dispersion by applying a high shearing power, such as a homomixer.

To the polymer polyol (A) of the present invention, a solvent and a flame retardant may be added as required. As the solvent, those mentioned above as the diluent (c) may be used. From the viewpoint of the viscosity of the polymer polyol, etc., unsaturated aliphatic hydrocarbons and aromatic hydrocarbons are preferred.

As the flame retardant, various flame retardants may be used (such as those described in JP 2005-162791 A, etc., as well as phosphoric acid esters, halogenated phosphoric acid esters, melamines, phosphazenes, etc.). From the viewpoint of the viscosity of the polymer polyol, those having a low viscosity (not more than 100 mPa·s/25° C.) are preferable, and tris(chloroethyl)phosphate and tris(chloropropyl)phosphate, among the halogenated phosphoric acid esters, are more preferable.

The amounts (wt %) of the solvent and the flame retardant used in the polymer polyol (A) are preferably not more than 10 wt % each, based on the total weight of the polymer particles (JR) and the polyol (PL). From the viewpoint of the viscosity of the polymer polyol, the inflammability of the polyurethane, and the mechanical properties of the polyurethane to be obtained, the amounts are more preferably 0.01 to 5 wt % each, and further more preferably 0.05 to 3 wt % each.

The polymer polyol (A) of the present invention may be used as a polyol used in the production of a polyurethane (polyurethane elastomer, polyurethane foam, etc.). More specifically, a polymer polyol (A) or a polyol component (Po) containing (A), and an isocyanate component (Is) comprising polyisocyanate [hereinafter sometimes a composition composed of (Po) and (Is) is referred so as a “polyurethane-forming composition”] are caused to react by a known method {a method described in JP 2004-263192 A (corresponding to US Patent Application Pub. No. 2003/4217 A1), etc.}, whereby a polyurethane can be obtained.

As the polyol component (Po) used for producing a polyurethane, besides the polymer polyol (A) of the present invention, a polyol and a known polymer polyol other than (A) may be used as required, as a raw material for producing a polyurethane, within a range such that the effects of the present invention are not hindered.

As the polyol, any of the polyols (PL) mentioned above may be used. As the known polymer polyol, any of the polymer polyols described in JP 2005-162791 A, JP 2004-263192 A (corresponding to US Patent Application Pub. No. 2003-4217 A1), etc. may be used.

The amount (wt %) of the polyol used may be adjusted appropriately from the viewpoint of the mechanical properties of the polyurethane to be obtained, and it is preferably 1 to 1,000 wt % based on the weight of the polymer polyol (A).

The amount (wt %) of the known polymer polyol other than the polymer polyol (A) used is preferably 1 to 100 wt % based on the weight of (A), from the viewpoint of the mechanical properties of the polyurethane, and the reduction of the dogging in a strainer and a discharge outlet of a producing device.

The amount (wt %) of the polymer polyol (A) used in the polyol component (Po) is preferably 10 to 100 wt %, more preferably 15 to 90 wt %, particularly preferably 20 to 80 wt %, and most preferably 25 to 70 wt %, from the viewpoint of the mechanical properties of the polyurethane to be obtained and the viscosity of the polyol component.

As the isocyanate component (Is), known polyisocyanates conventionally used in the production of the polyurethane can be used (such as those described in JP 2005-162791 A, JP 2004-263192 A (corresponding to US Patent Application Pub. No. 2003/4217 A1, etc.).

Among these, the following are preferred from the viewpoint of the mechanical properties of the polyurethane: 2,4- and 2,6-trylene diisocyanate (TDI), mixtures of isomers thereof, and crude TDI (residues left as a result of purification of TDI); 4,4′- and 2,4′-diphenyl methane diisocyanate (MDI), mixtures of isomers thereof, and crude MDI (residues left as a result of purification of MDI); and modified polyisocyanates derived from these polyisocyates and containing a urethane group, a carbodiimide group, an allophanate group, a urea group, a biuret group, or an isocyanurate group.

An NCO index [equivalent ratio of NCO groups and active hydrogen atom-containing groups (NCO groups/active hydrogen atom-containing groups)×100] upon production of a polyurethane may be adjusted appropriately from the viewpoint of the mechanical properties of the polyurethane, and is preferably 80 to 140, more preferably 85 to 120, and particularly preferably 95 to 115.

In the production of the polyurethane, any of various types of catalysts used in a polyurethane-forming reaction {described in JP 2005-162791 A, JP 2004-263192 A (corresponding to US Patent Application Pub. No. 2003/4217 A1), etc.} can be used for accelerating a reaction. The amount (wt %) of the catalyst used is preferably not more than 10 wt %, and more preferably 0.001 to 5 wt %, based on the total weight of the polyurethane-forming composition.

In the production of the polyurethane, any of various types of foaming agents (described in JP 2006-152188 A, JP 2004-263192 A (corresponding to US Patent Application Pub. No. 2003/4217 A1), etc.} [e.g. water, HFC (hydrofluorocarbon), HCFC (hydrochlorofluorocarbon), methylene chloride, etc.] may be used, whereby a polyurethane foam can be obtained. The amount (wt %) of the foaming agent used may be changed according to a desired density of the polyurethane foam, and is not limited particularly. The amount however is preferably not more than 20 wt % based on the total amount of the polyurethane-forming composition.

In the production of the polyurethane foam, a foam stabilizer may be used further as required. As the foam stabilizer, any of various kinds of foam stabilizers {described in JP 2005-162791 A, JP 2004-263192 (corresponding to US Patent Application Pub. No. 2003/4217 A1), etc.} may be used. From the viewpoint of the uniformity of diameters of cells in a polyurethane foam, a silicone surfactant (e.g. polysiloxane-polyoxyalkylene copolymer) is preferable.

The amount (wt %) of the foam stabilizer used is preferably not more than 5 wt %, and more preferably 0.01 to 2 wt %, based on the total weight of the polyurethane-forming composition.

In the production of the polyurethane, a flame retardant may be used as required. Examples of the flame retardant include various types of flame retardants {described in JP 2005-162791 A, JP 2004-263192 A (corresponding to US Patent Application Pub. No. 2003/4217 A1), etc.}, such as melamines, phosphoric acid esters, halogenated phosphoric acid esters, and phosphazenes.

The amount (wt %) of the flame retardant used is preferably not more than 30 wt %, and more preferably 0.01 to 10 wt %, based on the total weight of the polyurethane-forming composition.

In the production of the polyurethane, at least one of other additives selected from the group consisting of a reaction retarder, a coloring agent, an internal mold release agent, an age resister, an antioxidant, a plasticizer, an antibacterial agent, and a filler (including a carbon black) may be used as required.

Production of the polyurethane can be carried out by any of various methods {described in JP 2005-162791 A, JP 2004-263192 A (corresponding to US Patent Application Pub. No. 2003/4217 A1), etc.}, such as the one shot method, the semiprepolymer method, and the prepolymer method.

In the production of the polyurethane, a conventionally used production device can be employed (such as a mechanical device at a low pressure or high pressure). When no solvent is used, a device such as a kneader or extruder can be employed. When a non-foamed or foamed polyurethane is to be produced, a closed mold or an open mold can be employed.

In the case where the polymer polyol (A) of the present invention is used, the dogging in a small opening of a production device used in the production of the polyurethane is reduced, whereby the maintenance of the device is facilitated and the productivity is improved. Particularly in the case of a foaming machine for a polyurethane foam, the clogging in a discharge head thereof is reduced significantly, whereby the productivity is improved outstandingly.

### EXAMPLES

The present invention is described further in detail with reference to the following examples. However, the present invention is not limited to these examples in any way. In the following, the values of percentages, parts, and ratio indicate those of percentages by weight, parts by weight, and ratio by weight, respectively, unless otherwise described.

The compositions, symbols, etc. of the materials used in the examples and comparative examples are as follows:

### (1) Polyol:

polyol (PL1-1): polyol obtained by block addition of PO-EO-PO in this order to glycerol, having a hydroxyl value of 56, and an internal EO unit content of 9% [trade name: “SANNIX (registered trademark) GP-3030”, produced by Sanyo Chemical Industries, Ltd.];

polyol (PL1-2): polyol obtained by block addition of PO-EO in this order to pentaerythritol, having a hydroxyl value of 32, and a terminal EO unit content of 14% [trade name: “Polyol 50”, produced by Sanyo Chemical Industries, Ltd.]; and

polyol (PL1-3): polyol obtained by addition of PO to bisphenol A, having a hydroxyl value of 216, and an terminal PO unit content of 56%

### (2) Radical Polymerization Initiator:

K-1: 2,2′-azobis(2,4-dimethylvaleronitrile) [trade name: “V-65” produced Wako Pure Chemical Industries, Ltd.];

K-2: 1,1′-azobis(2-methylbutyronitrile) [trade name: “V-59” produced Wako Pure Chemical Industries, Ltd.];

K-3: 1,1′-azobis(cyclohexane-1-carbonitrile) [trade name: “V-40” produced Wako Pure Chemical Industries, Ltd.]; and

K-4: dicumyl peroxide [trade name: “Percumyl D” produced by NOF Corporation].

### (3) Dispersant:

B-1: reactive dispersant obtained by coupling 0.14 mole of the polyol (PL1-2) and 0.07 mole of 2-hydroxyethyl methacrylate with use of 0.16 mole of TDI, the reactive dispersant having a hydroxyl value of 20, a ratio of the number of unsaturated groups/the number of nitrogen-containing groups of 0.22 [described in JP 2002-308920 A (corresponding to U.S. Pat. No. 6,756,414)]

### (4) Polyisocyanate:

TDI-80: “CORONATE T-80 (trade name)” [produced by Nippon Polyurethane Industry Co., Ltd.]

### (5) Catalyst:

Catalyst A: “Neostann U-28 (trade name)” (stannous octoate) [produced by Nitto Kasei Co., Ltd.]; and

Catalyst B: “DABCO (trade name)” (triethylenediamine) [produced by Nippon Nyukazai Co., Ltd.]

### (6) Foam Stabilizer

“SRX-280A (trade name)” (polyether siloxane polymer) [produced by Dow Corning Toray Silicone Co., Ltd.]

Methods of measurement and evaluation for Examples are as follows.

### <Content of Polymer Particles (JR):(PC)>

About 5 g of a polymer polyol is weighed precisely in a 50-ml SUS-made centrifuge tube, and this is assumed to be a polymer polyol weight (W1). This is diluted with 15 g of methanol added thereto. Using a refrigerated centrifuge [model: GRX-220, manufactured by TOMY SEIKO CO., LTD.], centrifugation is performed at 20° C., 18,000 rpm for 60 minutes. Supernatant fluid is removed with a glass pipette. Residual sediment is diluted with 15 g of methanol. Then, the operation of centrifugation and removal of supernatant fluid as described above is repeated three more times. The residual sediment in the centrifuge tube is dried under a reduced pressure of 2,666 to 3,999 Pa (20 to 30 torr), at 60° C., for 60 minutes, the weight of the sediment thus dried is measured, and this weight is assumed to be “(W2)”. The value determined by calculation of the following expression (4) is assumed to be the content of polymer particles:

Content of polymer particles(wt %)=(W2)×100/(W1) (4)

### <Volume-Average Particle Diameter>

In a 50-ml glass beaker, 30 ml of methanol is charged, 2 mg of a polymer polyol is added thereto, and they are stirred with a magnetic stirrer with a stirrer piece having a major diameter of 2 cm and a minor diameter of 0.5 cm, at 400 rpm for 3 minutes, whereby they are mixed and formed into a homogeneous liquid. Within 5 minutes after the mixing, the mixture is charged into a measurement cell, and the volume-average particle diameter of the same based on the volume is determined with a laser diffraction/scattering particle size distribution analyzer (model: LA-750, manufactured by HORIBA Ltd.].

### <Viscosity>

Viscosities of a polymer polyol are measured under conditions of 25° C. with a rheometer [manufactured by TA Instruments Japan Co.] at shearing speeds of 0.1 (l/s), 1.0 (l/s), and 10.0 (l/s), respectively.

### <Filtration Property>

300 g of a polymer polyol is heated to 70° C. with an air circulating dryer. An industrial woven wire mesh (JIS G3556) having a sieve opening of 0.045 mm, cut into a size of a filtration area, is fixed to a Buchner funnel having a filtration area diameter of 96 mm with aluminum adhesive tapes. The Buchner funnel is fixed at an upper opening of a bell jar, so as to be directly connected with a vacuum pump. The polymer polyol, whose temperature has been thus adjusted, is placed over the wire mesh on the Buchner funnel within 30 seconds after the temperature adjustment, and the vacuum pump [model: TSW-300, manufactured by SATO VAC INC.] is actuated within 60 seconds after the polymer polyol is placed on the wire mesh. The timing is started upon the actuation of the vacuum pump, and a time until the wire mesh face is partially visible is assumed to be a filtration time. A weight of the polymer polyol after the filtration is measured, and this is assumed to be (W4). A value calculated by the following formula (5) below is assumed to be a filtration property.

Filtration property(g/s·cm²)=(W4)(g)÷[filtration time (sec)×filtration area[72.4 cm²]] (5)

### <Overall Evaluation>

The filtration property, and the whiteness and physical properties of the polyurethane were evaluated according to the following criteria, and based on the evaluation results, overall evaluations were determined according to the following criteria.

### Evaluation Criteria:

(1) Filtration Property

⋆ not less than 0.12

⊚ not less than 0.10 and less than 0.12

◯ not less than 0.08 and less than 0.10

Δ not less than 0.06 and less than 0.08

x less than 0.06

(2) Whiteness

⋆ not more than 3

⊚ more than 3 and not more than 4.5

◯ more than 4.5 and not more than 5.5

Δ more than 5.5 and not more than 6.0

x more than 6

The whiteness is determined in accordance with JIS 8715-1999.

### Overall Evaluation

⋆ having a filtration property and a whiteness evaluated as better than ⊚ both, and having good foam properties

⊚ having a filtration property and a whiteness evaluated as better than ◯ both, and having good foam properties

◯ having a filtration property and a whiteness evaluated as better than Δ both, and having good foam properties

Δ having a filtration property and a whiteness evaluated as better than x both, and having good foam properties

x having a filtration property and a whiteness evaluated as x, or having poor foam properties

### Example 1

### Production of Polymer Polyol (A-1)

[First Step] Into a SUS-made pressure-resistant reaction container, 435 parts of the polyol (PL1-1), 35.0 parts of ACN, 84.0 parts of St, 7.6 parts of 2.2-mole PO adduct of allyl alcohol, 0.36 part of divinyl benzene, 44.2 parts of the dispersant (B-1), and 32 parts of xylene were charged at 25° C., and the temperature of the mixture was adjusted to 100° C. under agitation. 1.19 parts of the radical polymerization initiator (K-1), 0.36 part of (K-2), and 0.12 part of (K-3) were dissolved in 8 parts of xylene, and this solution was charged into the reaction container over 5 seconds and mixed with the foregoing mixture, so that polymerization was initiated. The polymerization reaction was initiated quickly within 1 minute after the radical polymerization initiator solution was added, and the temperature reached the highest level of about 160° C., about 6 minutes after. After the highest temperature was reached, aging was carried out for 10 minutes at a temperature of 150 to 170° C., and the temperature was decreased to 25° C. by a cooling operation. As a result, a polymer polyol intermediate (H1-1) was obtained.

[Second Step] Subsequently, into the reaction container containing the polymer polyol intermediate (H1-1), 40 parts of the polyol (PL1-1), 45.0 parts of ACN, 108.0 parts of St, 8.5 parts of 2.2-mole PO adduct of allyl alcohol, and 0.46 part of divinyl benzene were charged at 25° C., and the temperature of the mixture was adjusted to 95° C. under agitation. 1.53 parts of (K-1), 0.46 part of (K-2), and 0.15 part of (K-3) were dissolved in 11 parts of xylene, and this solution was charged into the reaction container over 5 seconds and mixed with the foregoing mixture, so that polymerization was initiated. The polymerization reaction was initiated quickly within 1 minute after the radical polymerization initiator solution was added, and the temperature reached the highest level of about 160° C., about 6 minutes after. After the highest temperature was reached, aging was carried out for about 10 minutes at a temperature of 150 to 170° C., and the temperature was decreased to 25° C. by a cooling operation. As a result, a polymer polyol intermediate (H1-2) was obtained.

[Third Step] Subsequently, into the reaction container containing the polymer polyol intermediate (H1-2), 50.0 parts of ACN, 120.0 parts of St, 8.5 parts of 2.2-mole PO adduct of allyl alcohol, and 0.51 part of divinyl benzene were charged at 25° C., and the temperature of the mixture was adjusted to 90° C. under agitation. 1.70 parts of (K-1), 0.51 part of (K-2), 0.17 part of (K-3), and 0.17 part of (K-4) were dissolved in 13 parts of xylene, and this solution was charged into the reaction container over 5 seconds and mixed with the foregoing mixture, so that polymerization was initiated. The polymerization was initiated quickly within 1 minute after the radical polymerization initiator solution was added, and the temperature reached the highest level of about 160° C., about 6 minutes after. After the highest temperature was reached, aging was carried out for about 10 minutes at a temperature of 150 to 170° C., and the temperature was decreased to 25° C. by a cooling operation. As a result, a polymer polyol intermediate (H1-3) was obtained. Non-reacted monomers and xylene were removed from (H1-3) by vacuum stripping at 2666 to 3999 Pa (20 to 30 torr) for two hours. As a result, a polymer polyol (A-1) was obtained. The polymer polyol (A-1) was measured and evaluated by the above-described methods. The results are shown in Table 1 below.

### Example 2

### Production of Polymer Polyol (A-2)

A polymer polyol (A-2) was obtained in the same manner as that of Example 1 except that in First Step in Example 1, 35.4 parts of the dispersant (B-1) was used instead of 44.2 parts of the dispersant (B-1). The polymer polyol (A-2) was measured and evaluated in the same manner as that of Example 1. The results are shown in Table 1 below.

### Example 3

### Production of Polymer Polyol (A-3)

A polymer polyol (A-3) was obtained in the same manner as that of Example 1 except that in First Step in Example 1, 30.9 parts of the dispersant (B-1) was used instead of 44.2 parts of the dispersant (B-1). The polymer polyol (A-3) was measured and evaluated in the same manner as that of Example 1. The results are shown in Table 1 below.

### Example 4

### Production of Polymer Polyol (A-4)

A polymer polyol (A-4) was obtained in the same manner as that of Example 1 except the following:

in First Step in Example 1, 48.2 parts of ACN, 77.4 parts of St, and 35.4 parts of the dispersant (B-1) were used instead of 35.0 parts of ACN, 84.0 parts of St, and 44.2 parts of the dispersant (B-1);

in Second Step thereof, 58.2 parts of ACN and 93.5 parts of St were used instead of 45.0 parts of ACN and 108.0 parts of St; and

in Third Step thereof, 63.2 parts of ACN and 105.5 parts of St were used instead of 50.0 parts of ACN and 120.0 parts of St.

The polymer polyol (A-4) was measured and evaluated in the same manner as that of Example 1. The results are shown in Table 1 below.

### Example 5

### Production of Polymer Polyol (A-5)

[First Step] Into a SUS-made pressure-resistant reaction container, 460 parts of the polyol (PL1-1), 60.0 parts of ACN, 78.5 parts of St, 8.1 parts of 2.2-mole PO adduct of allyl alcohol, 0.42 part of divinyl benzene, 37.9 parts of the dispersant (B-1), and 33.7 parts of xylene were charged at 25° C., and the temperature of the mixture was adjusted to 100° C. under agitation. 1.39 parts of the radical polymerization initiator (K-1), 0.42 part of (K-2), and 0.14 part of (K-3) were dissolved in 10 parts of xylene, and this solution was charged into the reaction container over 5 seconds and mixed with the foregoing mixture, so that polymerization was initiated. The polymerization reaction was initiated quickly within 1 minute after the radical polymerization initiator solution was added, and the temperature reached the highest level of about 160° C., about 6 minutes after. After the highest temperature was reached, aging was carried out for about 10 minutes at a temperature of 150 to 170° C., and the temperature was decreased to 25° C. by a cooling operation. As a result, a polymer polyol intermediate (H5-1) was obtained.

[Second Step] Subsequently, into the reaction container containing the polymer polyol intermediate (H5-1), 40 parts of the polyol (PL1-1), 70.0 parts of ACN, 91.6 parts of St, 8.7 parts of 2.2-mole PO adduct of allyl alcohol, and 0.48 part of divinyl benzene were charged at 25° C., and the temperature of the mixture was adjusted to 95° C. under agitation. 1.62 parts of (K-1), 0.48 part of (K-2), and 0.16 part of (K-3) were dissolved in 11.3 parts of xylene, and this solution was charged into the reaction container over 5 seconds and mixed with the foregoing mixture, so that polymerization was initiated. The polymerization reaction was initiated quickly within 1 minute after the radical polymerization initiator solution was added, and the temperature reached the highest level of about 160° C., about 6 minutes after. After the highest temperature was reached, aging was carried out for about 10 minutes at a temperature of 150 to 170° C., and the temperature was decreased to 25° C. by a cooling operation. As a result, a polymer polyol intermediate (H5-2) was obtained.

[Third Step] A continuous polymerization device (a SUS-made pressure-resistant reaction container to which a solution sending line and an overflow line were connected) was prepared, and in a reaction container (polymerization vessel) thereof, 2,400 parts of the polymer polyol (H5-2) prepared at Second Step was filled preliminarily, and was heated to 130° C. Subsequently, a raw material mixture solution (G) of 889.5 parts of (H5-2), 75.0 parts of ACN, 98.1 parts of St, 8.7 parts of 2.2-mole PO adduct of allyl alcohol, 0.52 part of divinyl benzene, 10 parts of xylene, and 1.73 parts of the radical polymerization initiator (K-2) was in-line-blended with a static mixer, and thereafter, it was merged at a rate of 100 parts per minute with a part (Z) of an overflow reaction solution that will be described later, and was continuously sent to the reaction container (polymerization vessel). On the other hand, from the polymerization vessel, the reaction solution was overflowed at a rate of 2,100 parts per minute, and the overflowed part (Z) of the reaction solution containing a polymer polyol was merged at a rate of 2,000 parts per minute with the mixture solution (G) immediately before entering the reaction container (polymerization vessel) while being cooled to 130° C., and was sent to the polymerization vessel. The remainder (i.e., 100 parts) of the overflowed reaction solution containing the polymer polyol was stored in a SUS-made storage tank for the intermediate. This operation was performed continuously, and polymerization was caused to occur at 130° C., whereby a polymer polyol intermediate (H5-3) (stored in the storage tank for the intermediate) was obtained. From the polymer polyol intermediate (H5-3) thus obtained, non-reacted monomers and xylene were removed by vacuum stripping at 2666 to 3999 Pa (20 to 30 torr) for two hours. As a result, a polymer polyol (A-5) was obtained. The polymer polyol (A-5) was measured and evaluated in the same manner as that of Example 1. The results are shown in Table 1 below.

### Example 6

### Production of Polymer Polyol (A-6)

A polymer polyol (A-6) was obtained in the same manner as that of Example 1 except the following:

in First Step in Example 1, 56.9 parts of ACN, 111.7 parts of St, 7.9 parts of 2.2-mole PO adduct of allyl alcohol, 0.51 part of divinyl benzene, 46.4 parts of the dispersant (B-1), 1.69 parts of the radical polymerization initiator (K-1), 0.51 part of (K-2), and 0.17 part of (K-3) were used instead of 35.0 parts of ACN, 84.0 parts of St, 7.6 parts of 2.2-mole PO adduct of allyl alcohol, 0.36 part of divinyl benzene, 44.2 parts of the dispersant (B-1), 1.19 parts of the radical polymerization initiator (K-1), 0.36 part of (K-2), and 0.12 part of (K-3);

in Second Step thereof, 66.9 parts of ACN, 131.3 parts of St, 0.59 part of divinyl benzene, 1.98 parts of (K-1), 0.59 part of (K-2), and 0.20 part of (K-3) were used instead of 45.0 parts of ACN, 108.0 parts of St, 0.46 part of divinyl benzene, 1.53 parts of (K-1), 0.46 part of (K-2), and 0.15 part of (K-3); and

in Third Step thereof, 71.9 parts of ACN, 141.1 parts of St, 0.64 part of divinyl benzene, 2.13 parts of (K-1), 0.64 part of (K-2), 0.21 part of (K-3), and 0.21 part of (K-4) were used instead of 50.0 parts of ACN, 120.0 parts of St, 0.51 part of divinyl benzene, 1.70 parts of (K-1), 0.51 part of (K-2), 0.17 part of (K-3), and 0.17 part of (K-4).

The polymer polyol (A-6) was measured and evaluated in the same manner as that of Example 1. The results are shown in Table 1 below.

### Example 7

### Production of Polymer Polyol (A-7)

[First Step] Into a four-neck flask provided with a thermoregulator, a vacuum rotor, a dropping pump, a decompression device, a Dimroth condenser, and nitrogen inlet and outlet, 255 parts of the polyol (PL1-1), 40.3 parts of (PL1-3), 57.4 parts of the dispersant (B-1), and 124 parts of xylene were charged, and after the atmosphere was replaced with nitrogen, the temperature of the mixture was increased to 130° C. under agitation in the nitrogen atmosphere (until the polymerization ended). Subsequently, a monomer-containing mixture solution (Z1) obtained by preliminarily mixing 142 parts of the polyol (PL1-1), 17.5 parts of the dispersant (B-1), 105 parts of ACN, 245 parts of styrene, 0.35 part of divinyl benzene, 3.50 parts of (K-2), and 10.5 parts of xylene was dropped continuously at a rate of 25 parts per minute by using the dropping pump, and after the dropping was completed, the polymerization was further caused to proceed at 130° C. for 30 minutes. Then, the temperature was decreased to 25° C. by a cooling operation, and a polymer polyol intermediate (H7-1) was obtained.

[Second Step] Two continuous polymerization devices (2-liter SUS-made pressure-resistant reaction containers to each of which a solution sending line and an overflow line were connected) were prepared, and the foregoing two devices (hereinafter referred to as first and second devices) were arranged in series in a manner such that the overflow line of a polymerization vessel of the first device was connected with an inlet of a polymerization vessel of the second device. 2000 parts of the polyol (PL1-1) was charged in each of the polymerization vessels of the first and second devices in advance, and was heated to 130° C. A material mixture solution (G1-1) obtained by mixing 127.8 parts of the polymer polyol (H7-1), 207 parts of (PL1-1), 6.77 parts of (PL1-3), 29.0 parts of (B-1), 29.0 parts of ACN, 67.7 parts of styrene, 1.21 parts of divinyl benzene, 0.97 part of (K-2), and 39.9 parts of xylene was in-line-blended with a static mixer, and thereafter, it was sent continuously to the polymerization vessel of the first device at a solution sending rate of 113 parts per minute. Thus, a polymer polyol intermediate (H7-2) overflowed from the polymerization vessel was obtained. The polymer polyol intermediate (H7-2) overflowed from the polymerization vessel of the first device was sent continuously to the polymerization vessel of the second device at a solution sending rate of 113 parts per minute.

[Third Step] A material mixture solution (G1-2) obtained by mixing (H7-2) overflowed from the polymerization vessel of the first device at a solution sending rate of 113 parts per minute, 118 parts of (PL1-1), 91.8 parts of ACN, 214 parts of styrene, 3.06 parts of (K-2), and 9.2 parts of xylene was in-line-blended with a static mixer, and thereafter, it was sent continuously to the polymerization vessel of the second device at a solution sending rate of 96.9 parts per minute. A reaction solution overflowed from the polymerization vessel was stocked in a SUS-made receiver, whereby a polymer polyol intermediate (H7-3) was obtained. Non-reacted monomers and xylene were removed from (H7-3) by vacuum stripping at 2666 to 3999 Pa (20 to 30 torr) at 130 to 140° C. for two hours. As a result, a polymer polyol (A-7) was obtained. The polymer polyol (A-7) was measured and evaluated in the same manner as that of Example 1. The results are shown in Table 1 below.

### Comparative Example 1

### Production of Polymer Polyol (R-1)

A polymer polyol (R-1) was obtained in the same manner as that of Example 1 except the following:

in First Step in Example 1, 320 parts of the polyol (PL1-1), 45.0 parts of ACN, 108.0 parts of St, 0 part of 2.2-mole PO adduct of allyl alcohol, 0.46 part of divinyl benzene, 136.0 parts of the dispersant (B-1), and 0 part of xylene were used instead of 435 parts of the polyol (PL1-1), 35.0 parts of ACN, 84.0 parts of St, 7.6 parts of 2.2-mole PO adduct of allyl alcohol, 0.36 part of divinyl benzene, 44.2 parts of the dispersant (B-1), and 32 parts of xylene;

in Second Step thereof, 55.0 parts of ACN, 131.9 parts of St, 0 part of 2.2-mole PO adduct of allyl alcohol, and 0.56 part of divinyl benzene were used instead of 45.0 parts of ACN, 108.0 parts of St, 8.5 parts of 2.2-mole PO adduct of allyl alcohol, and 0.46 part of divinyl benzene; and

in Third Step thereof, 60.0 parts of ACN, 143.9 parts of St, 0 part of 2.2-mole PO adduct of allyl alcohol, and 0.61 part of divinyl benzene were used instead of 50.0 parts of ACN, 120.0 parts of St, 8.5 parts of 2.2-mole PO adduct of allyl alcohol, and 0.51 part of divinyl benzene.

The polymer polyol (R-1) was measured and evaluated in the same manner as that of Example 1. The results are shown in Table 1 below.

### Comparative Example 2

### Production of Polymer Polyol (R-2)

A polymer polyol (R-2) was obtained in the same manner as that of Example 1 except the following:

in First Step in Example 1, 450 parts of the polyol (PL1-1), 100.0 parts of ACN, 34.6 parts of St, 7.4 parts of 2.2-mole PO adduct of allyl alcohol, 0.40 part of divinyl benzene, 30.6 parts of the dispersant (B-1), and 34 parts of xylene were used instead of 435 parts of the polyol (PL1-1), 35.0 parts of ACN, 84.0 parts of St, 7.6 parts of 2.2-mole PO adduct of allyl alcohol, 0.36 part of divinyl benzene, 44.2 parts of the dispersant (B-1), and 32 parts of xylene;

in Second Step thereof, 110.0 parts of ACN, 38.1 parts of St, 7.7 parts of 2.2-mole PO adduct of allyl alcohol, and 0.44 part of divinyl benzene were used instead of 45.0 parts of ACN, 108.0 parts of St, 8.5 parts of 2.2-mole PO adduct of allyl alcohol, and 0.46 part of divinyl benzene; and

in Third Step thereof, 115.0 parts of ACN, 39.8 parts of St, 7.7 parts of 2.2-mole PO adduct of allyl alcohol, and 0.46 part of divinyl benzene were used instead of 50.0 parts of ACN, 120.0 parts of St, 8.5 parts of 2.2-mole PO adduct of allyl alcohol, and 0.51 part of divinyl benzene.

The polymer polyol (R-2) was measured and evaluated in the same manner as that of Example 1. The results are shown in Table 1 below.

### Comparative Example 3

### Production of Polymer Polyol (R-3)

From (H1-1) obtained in First Step of Example 1, non-reacted monomers and xylene were removed by vacuum stripping by the same method as that of Example 1. As a result, a polymer polyol (R-3) was obtained. The polymer polyol (R-3) was measured and evaluated in the same manner as that of Example 1. The results are shown in Table 1 below.

TABLE 1

| | | Example | | | | | | | Comparative Example | | |
|---|---|---|---|---|---|---|---|---|---|---|---|
| | | 1 | 2 | 3 | 4 | 5 | 6 | 7 | 1 | 2 | 3 |
| Polymer polyol | | A-1 | A-2 | A-3 | A-4 | A-5 | A-6 | A-7 | R-1 | R-2 | R-3 |
| Styrene (mol % based on total | | 54 | 54 | 54 | 44 | 39 | 49 | 54 | 55 | 15 | 54 |
| amount of ethylenically | | | | | | | | | | | |
| unsaturated compound) | | | | | | | | | | | |
| Acrylonitrile (mol % based | | 44 | 44 | 44 | 54 | 59 | 49 | 46 | 45 | 83 | 44 |
| on total amount of ethylenically | | | | | | | | | | | |
| unsaturated compound) | | | | | | | | | | | |
| Polymerization ratio (%) | | 94 | 94 | 93 | 94 | 93 | 93 | 94 | 93 | 95 | 90 |
| Content of polymer particles (PC) (wt %) | | 46 | 46 | 46 | 46 | 46 | 51 | 46 | 50 | 46 | 21 |
| Volume-average particle diameter (μm) | | 0.51 | 0.72 | 0.85 | 0.59 | 0.54 | 0.54 | 0.65 | 0.49 | 0.48 | 0.40 |
| Viscosity | N1 | 4.3 | 4.3 | 4.1 | 4.3 | 4.0 | 10.7 | 4.2 | 12.4 | 4.4 | 2.3 |
| (Pa · s) | N2 | 6.3 | 6.1 | 5.8 | 5.9 | 5.5 | 14.0 | 6.1 | 14.2 | 6.5 | 2.9 |
| | N3 | 5.4 | 5.3 | 5.2 | 5.4 | 4.5 | 15.0 | 5.3 | 15.2 | 5.8 | 2.6 |
| Formula | Formula (1) | Satisfy | Satisfy | Satisfy | Satisfy | Satisfy | Satisfy | Satisfy | Not | Satisfy | Not |
| | | | | | | | | | satisfy | | satisfy |
| | Formula (2) | Satisfy | Satisfy | Satisfy | Satisfy | Satisfy | Not | Satisfy | Not | Satisfy | Not |
| | | | | | | | satisfy | | satisfy | | satisfy |
| | Formula (3) | Satisfy | Satisfy | Satisfy | Satisfy | Satisfy | Not | Satisfy | Not | Satisfy | Not |
| | | | | | | | satisfy | | satisfy | | satisfy |

| | | | | | | | | | | |
|---|---|---|---|---|---|---|---|---|---|---|
| Filtration property (g/s · cm²) | 0.16 | 0.14 | 0.12 | 0.15 | 0.16 | 0.11 | 0.15 | 0.05 | 0.14 | 0.15 |
| Evaluation of polyurethane foam | Ex. 8 | Ex. 9 | Ex. 10 | Ex. 11 | Ex. 12 | Ex. 13 | Ex. 14 | Comp. | Comp. | Comp. |
| | | | | | | | | Ex. 4 | Ex. 5 | Ex. 6 |
| Overall evaluation | ⋆ | ⋆ | ⋆ | ⊚ | ◯ | ⊚ | ⋆ | X | X | X |

### Examples 8 to 14, and Comparative Examples 4 to 6

### Production of Polyurethane Foam

Polyurethane foams were produced with the polymer polyols (A-1 to A-7) obtained in Examples 1 to 7, respectively, and the comparative polymer polyols (R-1 to R-3) obtained in Comparative Examples 1 to 3, respectively, with mix proportions shown in Table 2 below, by the foaming operation described below. Physical properties of these foams were evaluated by the following method. The results are shown in Table 2.

### <Foaming Operation>

[1] Temperatures of the polymer polyol, the polyol (PL1-1), and polyisocyanate were adjusted to 25±2° C.

[2] The polymer polyol, the polyol (PL1-1), a foam stabilizer, water, and a catalyst were charged in this order into a 1-liter stainless steel-made beaker, and mixed at 25±2° C. under agitation. Polyisocyanate was added immediately to the mixture, and the mixture was agitated with an agitator [Homodisper; manufactured by TOKUSHU KIKA INDUSTRIES, Ltd] (agitation condition: 2000 rpm×8 seconds)

[3] After the agitation was stopped, the mixed contents in the beaker were charged into a 25 cm×25 cm×10 cm wooden box (at 25±2° C.) and were foamed, whereby a polyurethane foam was obtained.

TABLE 2

| | | Example | | | | | | | Comparative Example | | |
|---|---|---|---|---|---|---|---|---|---|---|---|
| | | 8 | 9 | 10 | 11 | 12 | 13 | 14 | 4 | 5 | 6 |
| Mix | Polymer polyol | 55 | 55 | 55 | 55 | 55 | 55 | 55 | 55 | 55 | 55 |
| proportion | Polyol (PL1-1) | 45 | 45 | 45 | 45 | 45 | 45 | 45 | 45 | 45 | 45 |
| (parts) | Water | 28 | 28 | 28 | 28 | 28 | 2.8 | 2.8 | 2.8 | 28 | 28 |
| | Catalyst A | 0.06 | 0.06 | 0.06 | 0.06 | 0.06 | 0.06 | 0.06 | 0.06 | 0.06 | 0.06 |
| | Catalyst B | 0.18 | 0.18 | 0.18 | 0.18 | 0.18 | 0.18 | 0.18 | 0.18 | 0.18 | 0.18 |
| | SRX-280A | 0.5 | 0.5 | 0.5 | 0.5 | 0.5 | 0.5 | 0.5 | 0.5 | 0.5 | 0.5 |
| | TDI-80 | 33.5 | 33.5 | 33.5 | 33.5 | 33.5 | 33.5 | 33.5 | 33.3 | 33.5 | 34.7 |

| | | | | | | | | | | |
|---|---|---|---|---|---|---|---|---|---|---|
| <Foam properties> | | | | | | | | | | |
| Density [kg/m³] | 34.6 | 34.7 | 34.6 | 34.6 | 34.8 | 34.4 | 34.6 | 34.9 | 34.4 | 34.2 |
| 25% ILD [kgf/314 cm²] | 28.2 | 28.1 | 27.8 | 28.5 | 28.4 | 31.2 | 29.9 | 30.2 | 28.2 | 18.9 |
| Tensile strength [kgf/cm²] | 1.65 | 1.63 | 1.58 | 1.62 | 1.54 | 1.76 | 1.75 | 1.48 | 1.48 | 1.22 |
| Tear strength [kgf/cm] | 0.62 | 0.64 | 0.60 | 0.66 | 0.58 | 0.62 | 0.65 | 0.54 | 0.58 | 0.49 |
| Elongation at break [%] | 114 | 110 | 108 | 115 | 112 | 110 | 115 | 95 | 112 | 125 |
| Compression set [%] | 2.8 | 2.9 | 2.5 | 2.5 | 2.8 | 2.8 | 2.8 | 3.8 | 2.3 | 2.4 |
| Whiteness | 2.5 | 2.5 | 2.6 | 3.2 | 4.6 | 2.5 | 2.5 | 2.6 | 6.2 | 2.6 |

### <Method for Evaluating Foam Properties>

(1) Density kg/m³): according to JIS K6400-1997 [item 5]
(2) 25% ILD (hardness) (kgf/314 cm²): according to JIS K6382-1995 [item 5.3]
(3) Tensile Strength (kgf/cm²): according to JIS K6301-1995 [item 3]
(4) Tear Strength (kgf/cm): according to JIS K6301-1995 [item 9]
(5) Elongation at break (%): according to JIS K6301-1995 [item 3]
(6) Compression set (%): according to JIS K6382-1995 [item 5.5]
(7) Whiteness: according to JIS 8715-1999

From the results shown in Tables 1 and 2, the following are found:

the polymer polyols of Examples 1 to 7 exhibited improved filtration properties, as compared with the polymer polyol of Comparative Example 1;

the polymer polyol of Comparative Example 2 exhibited a small viscosity, and hence an excellent filtration property; however, since the content of ACN was large, it exhibited an extremely poor result regarding the whiteness among the foam properties;

the polymer polyol of Comparative Example 3 exhibited a small viscosity, and hence an excellent filtration property; however, since the content of polymer particles was small, it exhibited an extremely small value of 25% ILD indicative of the foam hardness among the foam properties;

the polyurethane foams obtained with use of the polymer polyols of Examples 1 to 7 were superior to the polyurethane foams obtained with use of the polymer polyols of Comparative Examples 1 to 3 regarding evaluation of the mechanical properties of (2) to (6) and the whiteness described above; they had improved tear strengths in particular;

a polyurethane foam obtained with use of the polymer polyol of Comparative Example 1 exhibited a larger value of 25% ILD, but was poor about the other mechanical properties;

a polyurethane foam obtained with use of the polymer polyol of Comparative Example 2 exhibited significantly poor whiteness; and

a polyurethane foam obtained with use of the polymer polyol of Comparative Example 3 exhibited a significantly small value of 25% ILD.

It should be noted that as to the physical properties of a polyurethane foam, normally, if a polyurethane foam exhibits larger values of 25% ILD, tensile strength, tear strength, and elongation at break, the polyurethane foam is excellent regarding these properties; and if a polyurethane foam exhibits smaller value of whiteness and compression set, the polyurethane foam is excellent regarding these properties.

### INDUSTRIAL APPLICABILITY

The polymer polyol (A) of the present invention facilitates the maintenance of a device used for producing a polyurethane, since with the use of the polyurethane polyol (A), the dogging of a small opening of the polyurethane producing device is reduced, whereby the productivity of the polyurethane production significantly is improved; and the polymer polyol (A) also improves the mechanical properties of a polyurethane formed with the polymer polyol (A). Therefore, the polymer polyol (A) of the present invention can be used widely and suitably in polyurethane products in general, such as foams flexible, rigid, and semi-rigid foams, etc.), elastomers, and RIM reaction injection molding) products. In the case where it is used in the production of a polyurethane foam in particular, the polymer polyol (A) is preferable, since the physical properties of the polyurethane foam can be adjusted in balance.

The polyurethane formed with the polyurethane-forming composition of the present invention can be used for various applications widely; particularly, the polyurethane is used suitably as a polyurethane foam in interior parts of automobiles, interior products such as furniture, and the like.

1. A polymer polyol (A) comprising a polyol (PL) and polymer particles (JR), the polymer particles (JR) having an ethylenically unsaturated compound (E) as a constituent unit and being contained in the polyol (PL), wherein
a ratio of acrylonitrile in the ethylenically unsaturated compound (E) is 0 mol % to 67 mol %, and
relationship between a viscosity of the polymer polyol and a content (PC) of the polymer particles satisfies a formula (1) below, and/or satisfies formulae (2) and (3) below:
(N1)<0.9×(PC)−35 (1)
(N2)<1.17×(PC)−46 (2)
(N3)<1.37×(PC)−55 (3)
where
N1 represents a viscosity (Pa·s) of the polymer polyol at 25° C. at a shearing speed of 1.0 (l/s) measured by a rheometer,
N2 represents a viscosity (Pa·s) of the polymer polyol at 25° C. at a shearing speed of 0.1 (l/s) measured by a rheometer,
N3 represents a viscosity (Pa·s) of the polymer polyol at 25° C. at a shearing speed of 10.0 (l/s) measured by a rheometer, and
PC represents a content (wt %) of the polymer particles (JR) in the polymer polyol.

2. The polymer polyol according to claim 1, wherein a volume-average particle diameter of the polymer particles (JR) is 0.2 μm to 0.9 μm.

3. The polymer polyol according to claim 1, wherein the content (PC) of polymer particles is 35 wt % to 55 wt %.

4. The polymer polyol according to claim 1, wherein 0.1 wt % to 10 wt % of the ethylenically unsaturated compound (E) is (poly)oxyalkylene (with an alkylene group having 2 to 8 carbon atoms) ether of unsaturated alcohol (having 3 to 24 carbon atoms).

5. A method for producing the polymer polyol according to claim 1, the method comprising the step of polymerizing an ethylenically unsaturated compound (E) in a polyol (PL), in the presence or absence of a dispersant (B),
wherein 0.1 wt % to 10 wt % of the ethylenically unsaturated compound (E) is (poly)oxyalkylene (with an alkylene group having 2 to 8 carbon atoms) ether of unsaturated alcohol (having 3 to 24 carbon atoms).

6. The method for producing the polymer polyol according to claim 5, wherein a volume-average particle diameter of the polymer particles (JR) of the polymer polyol to be produced is 0.2 μm to 0.9 μm.

7. The method for producing the polymer polyol according to claim 5, wherein the content (PC) of the polymer particles of the polymer polyol to be produced is 35 wt % to 55 wt %.

8. A method for producing a polyurethane by causing a polyol component and an isocyanate component to react with each other, wherein as the polyol component, a polyol component containing the polymer polyol (A) according to claim 1 is used, the polymer polyol (A) being 10 wt % to 100 wt % based on a weight of the polyol component.

9. The method for producing a polyurethane according to claim 8, wherein a volume-average particle diameter of the polymer particles (JR) of the polymer polyol (A) is 0.2 μm to 0.9 μm.

10. The method for producing a polyurethane according to claim 8, wherein the content (PC) of the polymer particles of the polymer polyol (A) is 35 wt % to 55 wt %.

11. The method for producing a polyurethane according to claim 8, wherein 0.1 wt % to 10 wt % of the ethylenically unsaturated compound (E) is (poly)oxyalkylene (with an alkylene group having 2 to 8 carbon atoms) ether of unsaturated alcohol (having 3 to 24 carbon atoms).
